(19) United States
(12) Patent Application Publication
(10) Pub. No.: US 2010/0089335 A1
(43) Pub. Date: Apr. 15, 2010

(54) Pet carrier

(76) Inventor: Eric DelaBarre, Santa Monica, CA (US)

Correspondence Address: Cislo & Thomas LLP, 1333 2nd Street, Suite #500, Santa Monica, CA, 90401-4110, US

(21) Appl. No.: 12/287,870

(22) Filed: Oct. 14, 2008

(51) Int. Cl. A01K 1/03

(52) U.S. Cl. 119/497

(57) ABSTRACT

The present invention relates to a carrier for pets, namely a carrier having flexible side walls and a bottom having a padded insert for receiving the pet and comfortably transporting it in a soft, darkened space. The inventive container has two straps that serve to stabilize the carrier and permit the individual carrying the animal to easily strap the container over its shoulder or grip the straps in its hand. Inside the carrier, the padded insert is removably secured to the bottom and the side walls flexibly lift up from the bottom, enclosing the animal within the walls and safely in the cushioned insert.

### TECHNICAL FIELD

This application relates to a container for carrying pets.

### BACKGROUND ART

Transporting a pet can be a harrying experience. Often, it is necessary to contain the pet in a fixed space so that it may be moved easily and moved without the risk of the pet running away or coming into contact with another person or animal. Securing an animal in a fixed space; however, can be challenging. For example, it can be difficult to get the animal into a container, keep it secured in the container, and keep it at ease.

Existing pet carriers are made of plastic, metal mesh, or a combination of plastic and metal mesh, with a door for the animal to move in and out. They are bleak looking and can be frightening for animals, cats especially, as cats prefer soft, warm, textured, and dark spaces as opposed to the inside of existing pet carriers that are cold, hard, and bright. Many pets run and hide at the sight of the carrier. Not only is it difficult to find the animal to put in the carrier, but once it is found, it may be a struggle to get the animal through a small door of the carrier. Cats often find a way to resist being pushed into a carrier by deforming their bodies and flailing their limbs, and scratching and biting.

After placing the animal in the carrier, transporting it can cause extreme discomfort and unease for both the animal and the human transporting. Dangerous personalities of animals may surface due to the unfamiliar and uncomfortable carrier conditions, and the health of the animal may be at risk due to the increase in stress and anxiety caused.

Thus, there is a need in the art for a device to transport animals that is comfortable, preferably soft, warm, and dark, and easy to get the animal inside. Ideally, the device will be one in which the animal prefers to get into to sleep, relax, and play.

### DISCLOSURE OF INVENTION

The present invention is a container for carrying animals, especially cats, that is made of a soft, flexible material and a removable padded insert. The carrier may further include a firm, stabilizing disc in the lower half of the carrier to add stability. In transit, animals can comfortably rest in the padded insert in the bottom of the container, avoiding the problems of extreme discomfort and unease for both the animal and the human transporting, thwarting dangerous personalities of animals, and preserving animal health.

To keep the container clean, the padded insert can be removed and washed. It can even be replaced when worn out. The top of the container may be secured closed to prevent the animal from getting out when it is not supposed to. Also, the container has a breathable, mesh opening so that the animal may breathe easily and look out of its confined, comfortable space. To enhance the stability of the carrier and comfort of the animal, the carrier may include a supportive insert in the shape of the base of the carrier, most preferably a firm oval disc having a width sufficient to support the weight of an animal and remain firm, e.g., about 0.15 to 1.0 inches thick, preferably 0.25 inches thick. The supportive insert may be inserted into the carrier in a number of ways, including being slid into a bottom compartment in the bottom of the carrier or the bottom of the padded insert, and placed free form between the bottom of the carrier and the bottom of the padded insert.

The inventive container may be left out in the open when transporting is not necessary so that the animal can familiarize itself with it, and even crawl in and sleep, rest, and play. Familiarity and comfort with the inventive carrier enhances its usability as animals will be more likely to get in the carrier either on command or without a fight. This is extremely useful and helpful as carrying an animal can be stressful for both the individual carrying and for the animal being carried.

### BRIEF DESCRIPTION OF DRAWINGS

FIG. 1 is a perspective view of one embodiment of the inventive pet carrier in use.

FIG. 2 is a perspective view of one embodiment of the inventive pet carrier with the top open. The cut-away view at the dashed line in FIG. 2 appears in FIG. 6.

FIG. 3 is a side view of one embodiment of the inventive pet carrier in use showing an optional mesh opening for enhanced breathability, and a cat inside the carrier.

FIG. 4 is a top down view of the padded insert of one embodiment of the inventive carrier.

FIG. 5 is a bottom view of one embodiment of the inventive pet carrier showing the criss-cross straps.

FIG. 6 is a cut away view of FIG. 1 of the inventive pet carrier with the top of the padded insert appearing through the opening.

FIG. 7 is an exploded view of one embodiment of the inventive pet carrier with padded insert shown in dashed lines to above the carrier. The padded insert is removably fastened to the inside bottom of the carrier.

### MODES FOR CARRYING OUT THE INVENTION

In one embodiment of the present invention, the pet carrier is comprised of four side walls attached together having a height greater than their width and a top edge and a bottom edge, and an oval bottom secured to the bottom edge of each of the four side walls made of a fabric material, the oval bottom having an inside and an outside. The oval bottom on the inside of the carrier has one or more hook and loop fasteners to receive a padded oval insert. The side walls and oval bottom are preferably made of a breathable fabric material and in a preferred embodiment, the oval bottom is made of an abrasion resistant base, for example, a strong material such as canvas, leather, or multiple layers of a thinner material. The breathable fabric material may also be claw and teeth resistant to prevent the animal from scratching or biting a carrier through the side wall. On the top edge of the four side walls, the carrier may have a drawstring closure being laced through the top edge. The drawstring closure may include locking means, a locking means including a cinching nodule, a sleeve, or a knot and loop. In a preferred embodiment, the padded oval insert is releasably secured to the inside of the pet carrier on its oval bottom. The padded oval insert, having a top and a bottom, the bottom of the oval insert having an outer and inner surface, has a length greater than the width and is made of a plush fabric on the top and a waterproof material on the outer surface of the bottom, the waterproof material having one or more hook and loop fasteners for securing with the oval bottom on the inside of the carrier. Between the outer and inner surface of the bottom of the oval insert, the invention may also include a supportive disc insert as described below. The supportive disc insert can be slid in between the outer and inner surface of the bottom of the oval insert, and is of a size and shape that is substantially the same as the bottom of the padded oval insert and having a width capable of withstanding the weight of an animal and the force of the side walls of the carrier while in transit without noticeable bowing or flexing.

The pet carrier further comprises one or more shoulder straps secured to the four side walls that extend above the top edge of each of the four side walls and extend down around the outside of the oval bottom in a criss-cross orientation. The shoulder straps may be secured to the outside or the inside of the four side walls. The shoulder straps are preferably made of a strong, webbed material. The pet carrier also includes one or more side vents made of a mesh material in one or more of the four side walls, the side vents having a width greater than the height.

In a preferred embodiment, the one or more side vents of the carrier are in a square or oval shape. The carrier may further comprise one or more outer pockets attached to one or more of the four side walls, a leather cover on the outside of the oval bottom, and/or a top flap attached to the top edge of one or more of the outer side walls, the top flap including a securing mechanism to releasably attach the top flap to the outside of one or more of the outer side walls to close the top edge of each of the four side walls.

In yet another embodiment, the carrier comprises one side wall attached on its bottom edge to an oval base at an angle of less than 90 degrees, the top edge having fastening means to securely cinch the top edge of the carrier closed, the side wall made of a fabric material, one or more straps attached to the outside of the oval base, extending up through the base and attached to the inside of the side wall, and extending past the top of the side wall, and a padded insert that removably attaches to the bottom inside of the carrier. The fastening means including a drawstring, button and button holes, matching hook and loop pieces, hook and eye closures, cinching pieces, and combinations thereof.

In a preferred embodiment, the one or more straps are attached to the outside of the carrier. The straps overlap in a criss-cross orientation on the outside bottom of the carrier to enhance stability.

To further enhance the stability of the carrier and comfort of the animal, the carrier may include a supportive disc insert in the shape of the base of the padded oval insert, most preferably a firm oval disc having a width sufficient to support the weight of an animal and remain firm, e.g., about 0.15 to 1.0 inches thick, preferably 0.25 inches thick. The insert may be made of a material such as plexiglass, bamboo, pressed recycled paper or wood, or may be another ecologically friendly material such as a material made from recycled bottles or recycled sneakers. At a minimum, the material must be strong enough to withstand the weight of an animal and the force of the side walls of the carrier without collapsing or substantially bowing or bending. The supportive insert may be inserted into the carrier in a number of ways, including being slid into a bottom compartment in the bottom of the carrier or slid into the bottom of the padded oval insert, and placed free-form between the bottom of the carrier and the bottom of the padded insert. Where the supportive insert is slid into the bottom compartment of the carrier, the bottom of the carrier may be comprised of at least two layers of material with an opening on either the inside or outside of the carrier, the opening having a width capable of receiving the supportive insert. The opening may be secured closed with any mechanism to hold the insert in the compartment including one or more of the following: zipper, hook and loop fasteners, snaps, buttons, and an extra piece of fabric.

Alternatively, in a preferred embodiment, the supportive disc insert may be slid into the bottom of the padded oval insert between the inner and outer surface of the bottom through an opening in the bottom of the padded oval insert having a width capable of receiving the supportive insert. The opening may be secured closed with any mechanism to hold the insert in the compartment including one or more of the following: zipper, hook and loop fasteners, snaps, buttons, and an extra piece of fabric.

In yet another embodiment, the supportive disc insert may be placed free-form between the inside bottom of the carrier and the bottom of the padded insert.

The carrier may have fastening means such as a drawstring enclosure on the top edge of the side wall, and may optionally have locking means on the end of the drawstring. In a preferred embodiment, the carrier further comprises a mesh opening in the side wall. The mesh opening may be square, oval, rectangular, and is preferably greater in width than it is in height. The width of the mesh opening may be from 5 to 15 inches and the height may be from 3 to 10 inches. The mesh opening may be positioned just above the bottom of the carrier or may be positioned from one to ten inches from the bottom of the carrier. The mesh opening may be at a height where an animal inside the carrier can see out. Optionally, the carrier further comprises a pocket affixed to the outside of the side wall. The carrier may also have a flap attached to the top edge of the side wall and a securing means attached to the outer edge of the flap and the side wall to releasably connect the flap to the side wall and enclose the interior of the carrier. The securing means may be one or more snaps, hook and loop closures, buttons, or ties.

The padded oval insert has a top and a bottom, the bottom having an outer and inner surface. In between the outer and inner surface of the bottom, the padded oval insert may further include a supportive disc insert. The material of the padded oval insert may be fleece, flannel, cotton, or other material with a soft texture. In a preferred embodiment, the padded insert is oval and has raised side walls. Also, the center of the inner surface of the padded insert is not raised, but instead is hollowed out for an animal to snuggle inside the raised side walls. The length of the padded insert is longer than the width. In yet another preferred embodiment, the outer surface of the padded insert is covered with a waterproof, washable material. This will allow retention of any potential fluids from the animal that may occur when the animal is scared or in transit, and allows for easy cleanup. The removability of the insert also allows the animal to become familiar with the texture and scent of the insert and it can be used as a perch or resting place for the animal either outside or inside of the carrier. The underside of the padded insert, also referred to as the outer surface of the bottom of the padded oval insert, further comprises a securing mechanism to releasably attach it to the inside bottom of the carrier. The securing mechanism may be one or more strips of a hook and loop fastener, snaps, clips, or locking unit. Alternatively, the padded insert may have one or more securing mechanisms on the outer side walls that attach to the inside of the carrier, for example, securing mechanisms include one or more buttons on the outer side wall can be secured to button holes on the inside of the carrier, one or more snaps on the outer side wall can be secured to the corresponding receiving end of the one or more snaps on the inside of the carrier, or one or more hook and loop fastener strips on the outer side wall can be secured to a matching hook and loop fastener strip on the inside wall of the carrier.

The straps of the pet carrier may further comprise padding in the uppermost, inner edge of each of the straps. The padding softens the hold for the individual transporting the animal.

In a preferred embodiment, the width of the oval base of the carrier may be from about 10 to 18 inches and the length of the oval base of the carrier may be from about 13 to 25 inches. Also, the height of the one or more side walls of the carrier may be from about 15 to 25 inches. The upper diameter dissecting the opening formed by the top edge of the one or more side walls may be from about 15 to 40 inches and may be larger than the diameter of the oval bottom so that the one or more side walls of the carrier can be gathered down and around the padded oval insert, and tucked along the outer edge of the padded oval insert to create a soft base for the animal to climb into. The pet carrier may further comprise fabric ties, snaps, buttons, or hook and loop fasteners to secure the one or more side walls next to the outer edge of the padded oval insert to neatly fold the carrier to form an oval bed or base for the animal. The one or more straps may extend from about 6 to 15 inches above the top edge of the one or more side walls. The one or more straps preferably extend in loop fashion above the top edge of the one or more side walls, and then are fixed to the one or more side walls of the carrier, and then intersect on the outside, bottom of the carrier to add stabilization to the carrier.

In a most preferred embodiment, the carrier is of a size and shape to fit a household cat as cats are the most likely to benefit from the soft texture of the padded insert, the secure feeling of the enclosed fabric side walls, and are of a weight that is light enough to transport in a carrier over the transporter's shoulder or in hand. The carrier is also of a size and shape that can fit in the wheel well of a car, under an airplane seat, or in the back storage section of a station wagon, sport utility vehicle, or crossover vehicle. The carrier may also be modified in size and shape for smaller animals such as kittens or small dogs, or may be made larger for mature, adult cats, and larger lap dogs.

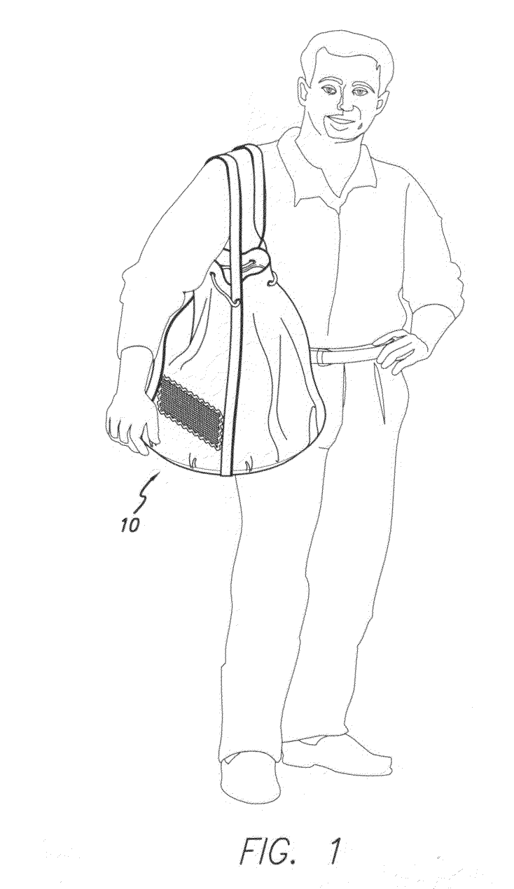

In the perspective view of FIG. 1, one embodiment of the inventive pet carrier 10 is shown in use over the arm and shoulder of an individual carrying an animal.

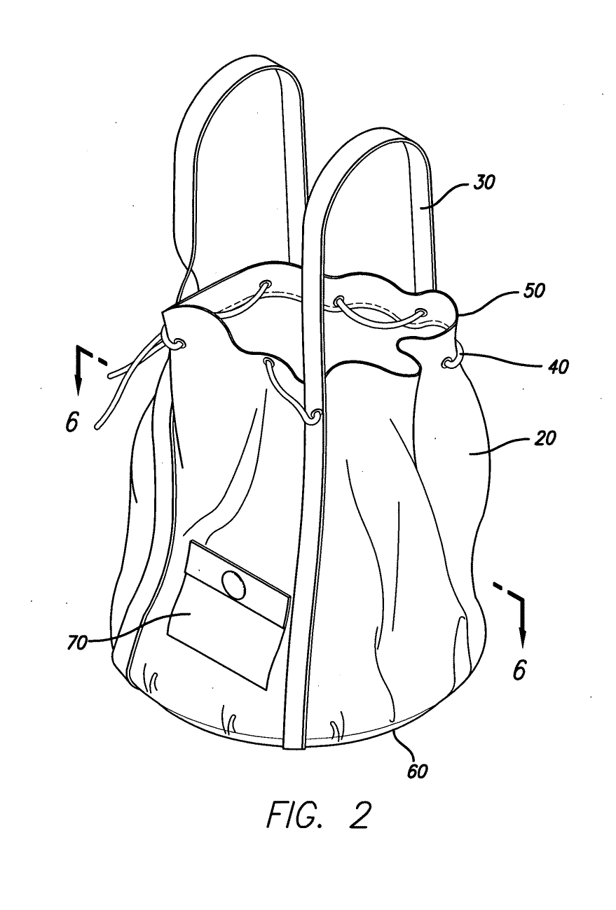

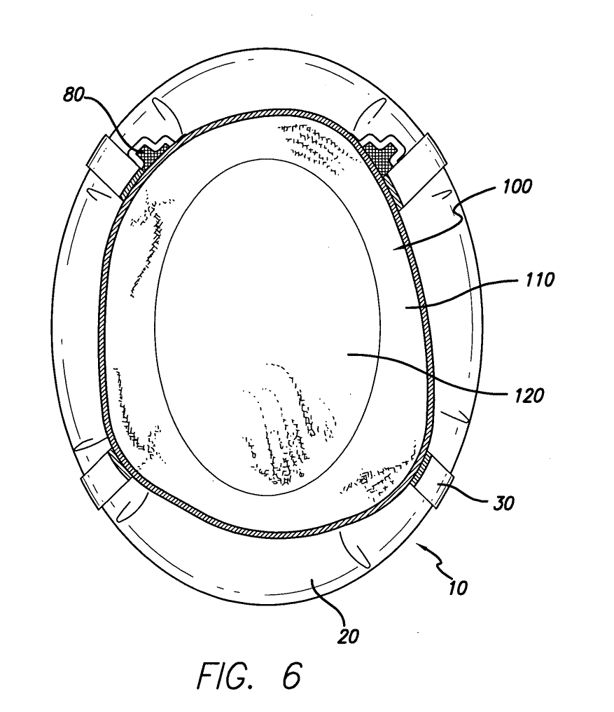

In the perspective view of FIG. 2, one embodiment of the inventive pet carrier 10 is shown with the top edge 50 of the one or more side walls 20 open, one or more side walls 20, one or more straps 30, a drawstring securing closure 40 in the top edge 50 of the one or more side walls 20, a bottom 60 having an oval shape that conforms to the outer edge of the padded insert inside of the carrier (not shown in FIG. 2), and an optional outer pocket 70 on the one or more side walls 20. FIG. 2 is a perspective view of one embodiment of the inventive pet carrier with the top open. The cut-away view at the dashed line in FIG. 2 appears in FIG. 6.

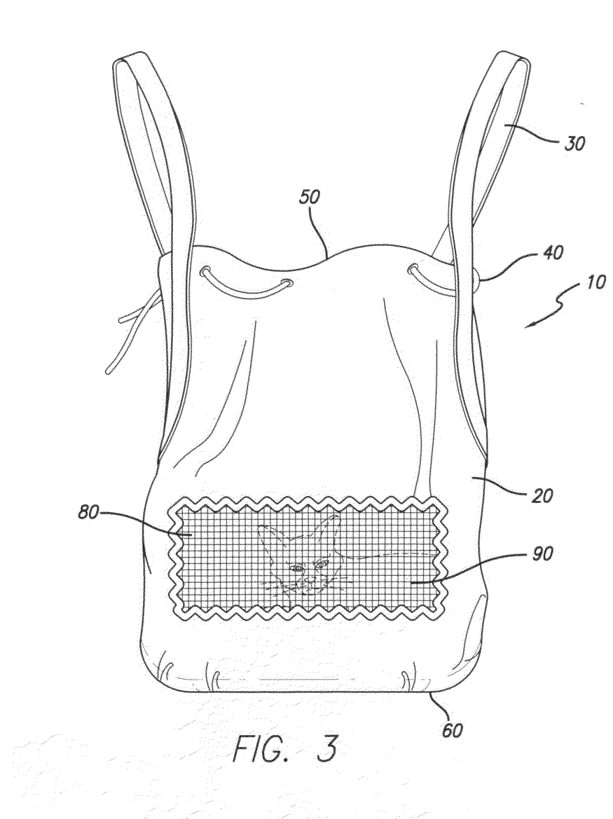

FIG. 3 is a side view of one embodiment of the inventive pet carrier 10 in use showing an optional mesh opening 80 for enhanced breathability, and a cat 90 inside the carrier. In the side view, the top edge 50 of the one or more side walls 20 is open. The pet carrier 10 has one or more side walls 20, one or more straps 30, a drawstring securing closure 40 in the top edge 50 of the one or more side walls 20, a bottom 60 having an oval shape that conforms to the outer edge of the padded insert inside of the carrier (not shown in FIG. 3), and a mesh opening 80 on the one or more side walls 20.

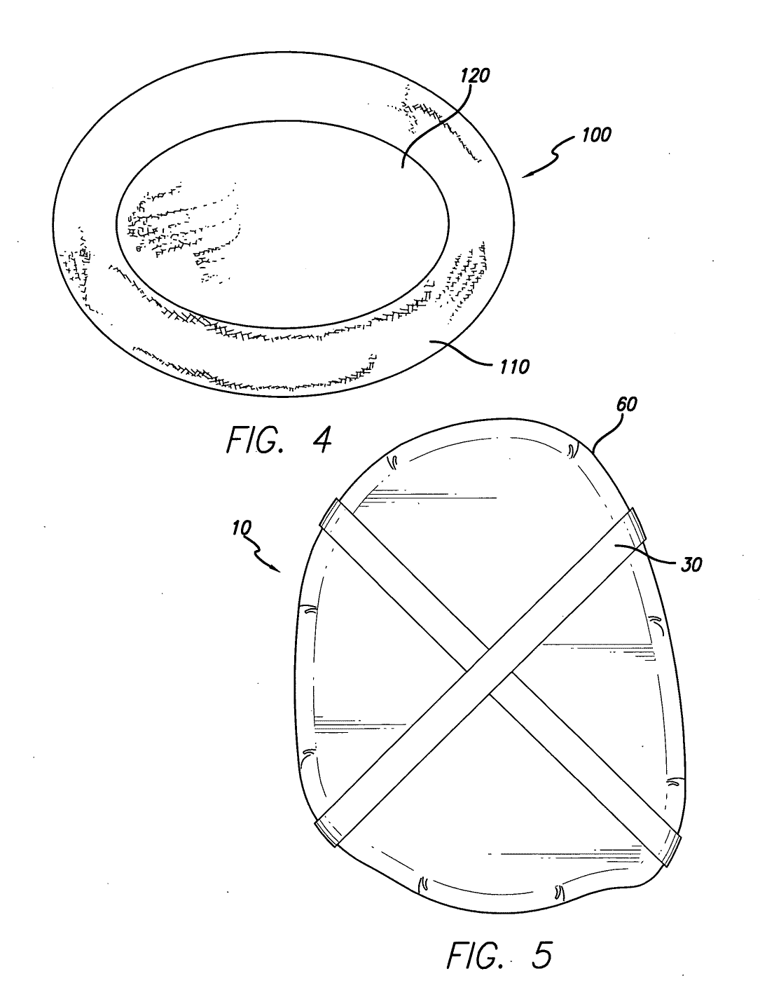

FIG. 4 is a top down view of the preferred embodiment of the padded insert 100 that is removably attached to the inside bottom of the inventive carrier. The padded insert 100 is oval in shape with the length longer than the width, and having a raised side wall 110 and a center 120 that is lower than the side wall so that an animal, preferably a cat, can snuggle inside the raised side wall 110 and rest in the center 120. FIG. 4 shows the padded insert 100 separated from the remainder of the pet carrier 10.

FIG. 5 is a bottom view of one embodiment of the inventive pet carrier 10 showing one or more straps 30 attached to the outside bottom 60 of the carrier 10 in an overlapping, intersecting, criss-cross orientation. The criss-cross creates more stability for the carrier and balances the weight of the animal inside the carrier to enhance the ease of transport and steadiness of the carrier. This provides a further sense of security and comfort for the animal as padded insert will remain at an almost constant balanced position because it is cradled by the criss-cross, intersecting straps.

FIG. 6 is a cutaway view of FIG. 1 of the inventive pet carrier 10 with the top of the padded insert 100, its side wall 110 and center 120 appearing through the opening. The one or more side walls 20 and one or more straps 30 are shown in cutaway fashion so that the padded insert in its secured position can be viewed. Also, a partial view of the mesh opening 80 is shown.

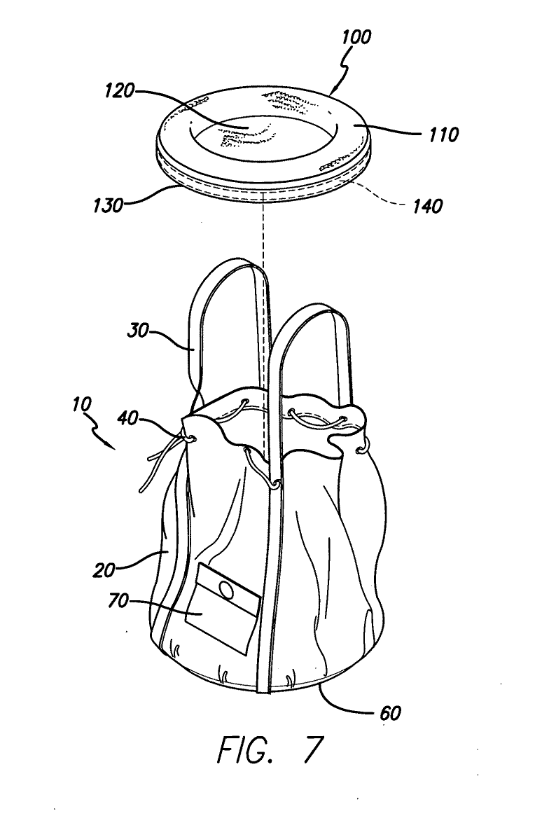

FIG. 7 is an exploded view of one embodiment of the inventive pet carrier 10 with padded insert 100 having a raised side wall 110 and a center 120 lower than the side wall 110 shown above the carrier and connected to the carrier with a dashed line to show that the padded insert 100 can be inserted or removed from the carrier 10 through the top edge 50. The padded insert 100 is removably fastened to the inside bottom of the carrier 10. The inventive pet carrier 10 is shown with the top edge 50 of the one or more side walls 20 open, one or more side walls 20, one or more straps 30, a drawstring securing closure 40 in the top edge 50 of the one or more side walls 20, a bottom 60 having an oval shape that conforms to the outer edge of the padded insert 100 inside of the carrier (shown raised above the carrier), and an optional outer pocket 70 on the one or more side walls 20. The bottom of the padded insert 100 having an outer 130 and inner surface, the inner surface hidden from view, and between the inner and outer 130 surface is a supportive disc insert 140 in the shape of the base of the padded oval insert that can be slid into place to add additional support for the carrier 10. The supportive disc insert 140 in the figure lends shape to the padded oval insert 110 and due to the location of the supportive disc insert 140 in the bottom of the padded oval insert, it is hidden from the outer view and shown in dashed lines.

### INDUSTRIAL APPLICABILITY

The inventive device has industrial applicability for all types of household animals, especially cats, to meet the needs of one seeking to transport, carry, or otherwise contain and/or move the animal in a secure, easy, and lightweight fashion.

I claim:

1. A pet carrier comprising:
a. four side walls attached together having a height greater than their width and made of a flexible fabric material and having a top edge and a bottom edge,
b. an oval bottom secured to the bottom edge of each of the four side walls made of a fabric material having an inside and an outside, the oval bottom on the inside of the carrier having one or more hook and loop fasteners,
c. a drawstring closure with a securing mechanism attached to the drawstring, the drawstring closure being laced through the top edge of each of the four side walls,
d. a padded oval insert releasably secured inside the pet carrier to the oval bottom having a length greater than the width, a top, and a bottom, the bottom having an outer and inner surface, the padded oval insert made of a plush fabric on the top and a waterproof material on the outer surface of the bottom, the waterproof material having one or more hook and loop fasteners to secure the padded oval insert to the hook and loop fasteners on the oval bottom on the inside of the carrier,
e. one or more shoulder straps secured to the outside of the four side walls, extending above the top edge of each of the four side walls and extending down around the outside of the oval bottom in a crisscross orientation, the shoulder straps made of a strong, webbed material, and
f. one or more side vents made of a mesh material in one or more of the four side walls having a width greater than the height.

2. The pet carrier of claim 1 wherein the one or more side vents is square in shape.

3. The pet carrier of claim 1 wherein the one or more side vents is oval in shape.

4. The pet carrier of claim 1 further comprising one or more outer pockets attached to one or more of the four side walls.

5. The pet carrier of claim 1 further comprising a leather cover on the outside of the oval bottom.

6. The pet carrier of claim 1 further comprising a supportive disc inserted into the bottom of the padded oval insert between the outer and inner surface.

7. A flexible pet carrier comprising:
a. one side wall having a top edge and a bottom edge and an inside and an outside, the side wall being attached on its bottom edge to an oval base at an angle of less than 90 degrees, the top edge having fastening means to securely cinch the top edge of the carrier closed, the side wall made of a fabric material, and
b. one or more straps attached to the oval base, extending up through the base and attached to the inside of the side wall, and extending past the top of the side wall, and
c. a padded insert having a top and a bottom, the bottom having an outer and inner surface, removably attached to the inside bottom of the pet carrier.

8. The pet carrier of claim 7 wherein the one or more straps are attached to the outside of the bottom of the carrier in a criss-cross orientation.

9. The pet carrier of claim 7 the fastening means being a drawstring enclosure on the top edge of the side wall.

10. The pet carrier of claim 9 having locking means attached to the drawstring.

11. The pet carrier of claim 7, further comprising a mesh opening in the side wall.

12. The pet carrier of claim 7, further comprising a pocket affixed to the outside of the side wall.

13. The pet carrier of claim 7, further comprising a flap attached to the top edge of the side wall and securing means attached to the outer edge of the flap and the side wall to releasably connect the flap to the side wall and enclose the interior of the carrier.

14. The pet carrier of claim 11, wherein the mesh opening is rectangular in shape.

15. The pet carrier of claim 11, wherein the mesh opening is oval in shape.

16. The pet carrier of claim 7, wherein the padded insert is comprised of fleece material.

17. The pet carrier of claim 7, further comprising a supportive disc inserted into the bottom of the padded insert between the outer and inner surface.

18. The pet carrier of claim 7, wherein the bottom of the padded insert is covered with a waterproof material.

19. The pet carrier of claim 7, wherein the outer surface of the padded insert further comprises a securing mechanism to releasably attach it to the inside bottom of the carrier.

20. The pet carrier of claim 7, the strap having an uppermost inner edge and further comprising padding in the uppermost inner edge of each of the straps.
